(19) United States
(12) Patent Application Publication
(10) Pub. No.: US 2004/0075640 A1
(43) Pub. Date: Apr. 22, 2004

(54) Optical input device

(75) Inventor: Zhi-Jian Liao, Taipei Hsien (TW)

Correspondence Address: BACON & THOMAS, PLLC, 625 SLATERS LANE, FOURTH FLOOR, ALEXANDRIA, VA, 22314

(73) Assignee: KYE SYSTEMS CORP., Taipei (TW)

(21) Appl. No.: 10/273,303

(22) Filed: Oct. 18, 2002

(51) Int. Cl. G09G 5/00

(52) U.S. Cl. 345/156

(57) ABSTRACT

An optical input device includes a floating board arranged to be moved by the user's finger and confined in an opening on the case of the input device. A sensor located within the case will detect the movement of the floating board as to generate a corresponding cursor-moving signal to a computer system. The present invention may be a closed system to eliminate contamination by the grease, dust from the ambient. Further, the present invention can avoid the harm to a user's hand or shoulder while moving merely by a finger.

### FIELD OF THE INVENTION

The present invention relates to an optical input device, and particularly to an input device that optically senses movement of a user's finger so as to generate a cursor control signal. Even though finger movement is sensed optically, the working platform can be made of any material and can have any color. In addition, the distance the finger must be moved is minimized, thereby reducing the risk of repetitive stress injuries, and the device may be sealed to eliminate contamination that would otherwise affect optical sensing of finger movement.

### BACKGROUND OF THE INVENTION

Common computer input or pointing devices include keyboards, mouses, touch pads, and so forth. Of these, the mouse is the most popular. The mouse can conventionally be either a ball type or optical type device. A ball type mouse uses a ball rolling over a working platform to turn a grating shaft in each X-Y coordinates axis and generate a corresponding cursor-moving signal, while an optical mouse projects a light beam and uses a sensor to detect changes in the reflection of the light beam from a platform due to variations or changes in an image beneath the mouse as the mouse is moved over the platform. An alternative type of mouse is the upside-down ball type mouse, which utilizes a friction wheel connecting to a grating shaft in each X-Y coordinates axis, and that is further contacted with a moving plate. When a user moves the moving plate, the wheel turns the grating shaft in each X-Y coordinate axis, thereby performing the function of the above-mentioned ball. This type of mouse is disclosed in Taiwan patent publication number TW449078.

The optical mouse has the advantage that there is no need to clean contamination from the surface of the ball, which is the main defect of a ball type mouse. A red LED is usually employed as a light source. However, the surface color of the working platform has to be carefully chosen so as to control the cursor precisely. Further, if the platform is in a transparent material, such as glass, the optical mouse will not operate. In addition, movement of either type of mouse by hand can lead to repetitive stress injuries, and even an optical mouse requires cleaning in that the transparent surfaces through which light is projected and sensed are subject to contamination by dirt, degrading the performance of the mouse.

The problem of injury due to hand movement is addressed in WO 02/056243, which discloses a finger control input device that uses just one finger moving on a transparent board to cause a corresponding movement of a cursor on a display.

However, this type of input device still requires the finger to be moved a relatively large distance. Fingers usually have a width of less than half an inch. Therefore, when the sensing resolution is about 800 dpi, the finger must be moved at least one to two inches to move the cursor on the full screen. That is, one must move the finger two to three times its width to adequately control the cursor movement, which can cause repetitive stress injuries to a user's hand, arm, or shoulder, and which necessitates that the mouse pad be made according to a minimum requirement in area.

In addition, the transparent platform optical input device of WO 02/056243 has the disadvantage that the skin of the finger cannot reflect the light from a light source to a sensor properly. As a result, some sort of optical bandpass filter must be installed under the finger or the transparent board.

### SUMMARY OF THE INVENTION

The primary object of the present invention is to provide an optical input device, which will not be affected by the surface color of a working platform, or contaminated by the dust, grease or the like.

Another object of the present invention is to provide input device of the type that senses movement of a user's finger, and yet that minimizes the necessary movement in order to prevent injury to the user's hand, arm, or shoulder.

These objectives are accomplished, according to a preferred embodiment of the invention, by providing an input device of the type that senses movement of the user's finger, and that is made up of a case including a light source, a floating board arranged to be moved by the user's finger and confined within an opening in the case, and a sensor. The light source will project a light through the opening in the case to where the floating board is located. The light will be reflected, and detected by the sensor, so as to move the cursor in X-Y direction on a display.

The various objects and advantages of the present invention will be more readily understood from the following detailed description when read in conjunction with the appended drawing.

### BRIEF DESCRIPTION OF THE DRAWINGS

FIG. 1 is a sectional view of the first embodiment according to the present invention.

FIG. 2 is a sectional view of the second embodiment according to the present invention.

FIG. 3 is a sectional view of the third embodiment according to the present invention.

FIG. 4 is a sectional view of the fourth embodiment according to the present invention.

FIG. 5 a further application in a keyboard according to the fourth embodiment.

### DETAILED DESCRIPTION OF THE PREFERRED EMBODIMENTS

The present invention is an optical input device that can be connected with a desk-top computer, notebook computer, PDA or the like by wires or by a wireless connection. In particular, the invention is an improvement in arrangement of light source, sensor, and transparent pad through which the finger is sensed. The electronic components of the input device are known and therefore not described in detail herein.

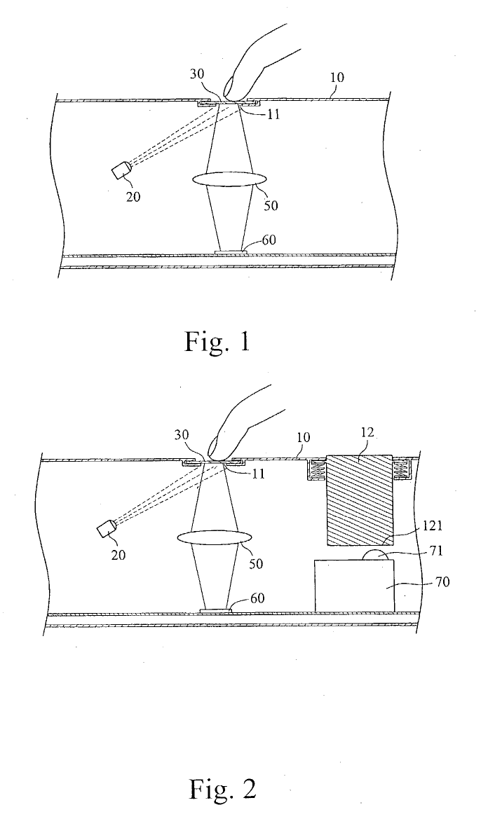

FIG. 1 shows the first embodiment of the present invention. The case 10 has a space to contain a light source 20, a floating board 30, a lens 50 and a sensor 60 therein. An opening 11 is located on the surface of the case 10. The light source 20 may be, but is not limited to, a conventional LED, which according to the invention, projects a light beam toward the opening 11 and the bottom surface of the floating board 30. Movement of the floating board 30 causes variations in the reflection of the light beam as the board is moved. For example, the variations may result from the micro-texture of the board surface, or from any other property of the floating board that has an effect on reflection of light therefrom.

The floating board 30 is confined within the opening 11, and can be moved in an X-Y direction. A top surface of the floating board 30 faces outside the case 10, and a bottom surface faces inside the case 10. To prevent contamination by dust, a seal may be included to seal the opening while permitting movement of the board within the opening. When a user uses a finger to move the floating board 30, the sensor 60 will detect a reflected light beam from the bottom surface of the floating board 30 through lens 50. Therefore, a cursor-moving signal will be generated.

FIG. 2 shows the second embodiment of the present invention. The case 10 has a space to contain a light source 20, a floating board 30, a lens 50 and a sensor 60 therein. An opening 11 is located on the surface of the case 10. A top surface of the floating board 30 faces outside the case 10, and a bottom surface faces inside the case 10. The light source 20 may again be an LED, which projects a light beam toward the opening 11 and the bottom surface of the floating board 30. A button 12 is located on the case 10 having a pressing portion 121. A switch 70 having a pressing end 71 is located under the pressing portion 121 of the button 12. When a user uses a finger to move the floating board 30, the sensor 60 will detect a reflected light beam from the bottom surface of the floating board 30 through lens 50. Movement of the floating board 30 causes variations in the reflection of the light beam as the board is moved. Therefore, a cursor-moving signal will be generated. Furthermore, the user can use another finger to press the button 12, forcing pressing portion 121 to depress pressing end 71 and thereby activate the switch 7 to output a button-clicking signal. The button-clicking signal can be further defined according to driving software, although a left button-clicking signal is the most commonly used.

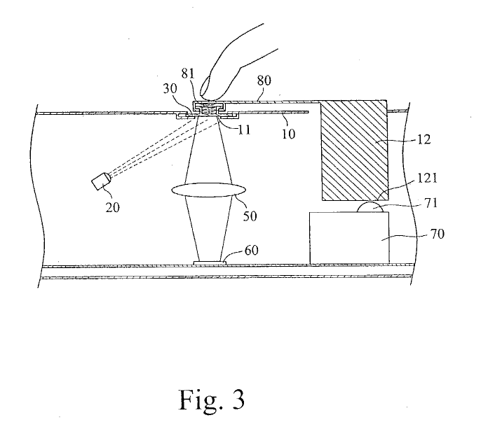

FIG. 3 shows the third embodiment of the present invention. The case 10 has a space to contain a light source 20, a floating board 30, a lens 50 and a sensor 60 therein. An opening 11 is located on the surface of the case 10. A top surface of the floating board 30 faces outside the case 10, and a bottom surface faces inside the case 10. A light source 20 such as an LED projects a light beam toward the opening 11 and the bottom surface of the floating board 30. Movement of the floating board 30 causes variations in the reflection of the light beam as the board is moved. A button 12 is located on the case 10 and has a pressing portion 121. A switch 70 having a pressing end 71 is located under the pressing portion 121 of the button 12. A connecting plate 80 links the floating board 30 with the button 12 to move together, and a spring 81 is positioned between one end of the connecting plate 80 and the floating board 30 that enables the clicking (an up and down movement) of the connecting plate 80 on the floating board 30 to cause the button 12 to activate switch 70.

When a user uses a finger to move the floating board 30, the sensor 60 will detect a reflected light beam from the bottom surface of the floating board 30 through lens 50. Therefore, a cursor-moving signal will be generated. In addition, the user can directly move the floating board 30 and press the button 12 by using the same finger to activate the switch 7 to output a button-clicking signal.

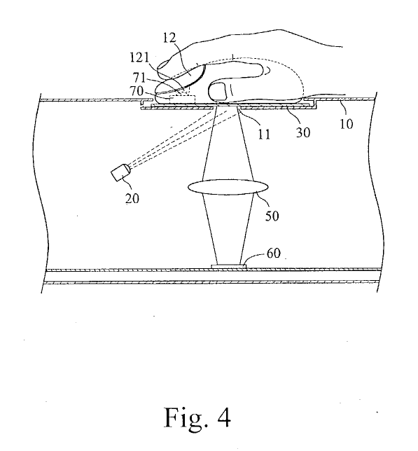

FIG. 4 shows the fourth embodiment of the present invention. The case 10 has a space to contain a light source 20, a floating board 30, a lens 50 and a sensor 60 therein. An opening 11 is located on the surface of the case 10. A top surface of the floating board 30 faces outside the case 10, and a bottom surface faces inside the case 10. A light source 20 such as an LED projects a light beam toward the opening 11 and the bottom surface of the floating board 30. Movement of the floating board 30 causes variations in the reflection of the light beam as the board is moved. The floating board 30 is further connected to a mouse-like housing to support the user's palm. A button 12 is located within the mouse-like housing having a pressing portion 121. When a user uses his hand to move the mouse-like housing together with the floating board 30, the sensor 60 will detect a reflected light beam from the bottom surface of the floating board 30 through lens 50. Therefore, a cursor-moving signal will be generated.

A switch 70 electrically connected to the case 10 having a pressing end 71 is located under the pressing portion 121 of the button 12. The user can press the button 12 forcing pressing portion 121 to depress pressing end 71 and activate the switch 7 to output a button-clicking signal.

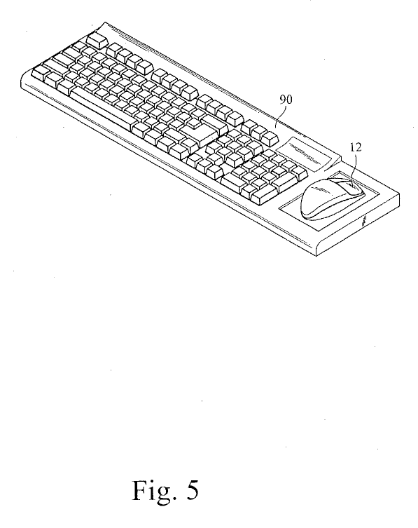

FIG. 5 illustrates a further application according to the fourth embodiment, in which the mouse-shape housing is positioned on a side of a keyboard, thereby eliminating the need for a large working platform such as is required for operating a known mouse.

The present invention can achieve the following achievements:

1. It minimizes the size of the input device to as small as possible.

2. It is a closed system that is unaffected by the color or material of the working platform surface.

3. It prevents injury to the user's hand, arm, or shoulder.

Having thus described preferred embodiments of the present invention in detail, it will nevertheless be appreciated by those skilled in the art that the illustrated embodiments may be varied in many ways. Such variations are not to be regarded as a departure from the spirit and scope of the present invention, and all such modifications as would occur to one skilled in the art are intended to be included within the scope of the following claims.

What is claimed is:

1. An optical input device, comprising:
a case;
a floating board arranged to be moved on the case and having a top surface facing outside the case and a bottom surface facing inside the case;
a light source that projects a light beam toward the bottom surface of the floating board,
a sensor arranged to detect a light beam reflected from the floating board;
whereby the movement of the floating board will cause a corresponding cursor-moving signal on a display.

2. The input device as claimed in claim 1, wherein the case has an opening thereon, and the floating board is located within the opening.

3. The input device as claimed in claim 1, wherein a lens is located between the sensor and the opening.

4. The input device as claimed in claim 1, wherein the light source is a light emitting diode (LED).

5. The input device as claimed in claim 1, wherein the case has at least a button and a corresponding switch for providing a click signal in addition to the cursor-moving signal.

6. The input device as claimed in claim 5, wherein a spring is located between the button and the case.

7. The input device as claimed in claim 1, further comprising a switch arranged to be activated when a user presses the floating board.

8. The input device as claimed in claim 7, wherein the floating board is further connected to a button arranged to activate the switch when the user presses the floating board.

9. The input device as claimed in claim 1, wherein the floating board is connected to a computer mouse-shape-like housing.

10. The input device as claimed in claim 9, wherein the housing has at least a button and a corresponding switch for providing a click signal in addition to the cursor-moving signal.

11. The input device as claimed in claim 9, wherein the housing is positioned on a side of a keyboard.

12. The input device as claimed in claim 9, wherein the input device is a closed system to prevent ingress of contaminants.
